(19) United States
(12) Patent Application Publication
(10) Pub. No.: US 2020/0108332 A1
(43) Pub. Date: Apr. 9, 2020

(54) Combination Of An Integrated Skimmer With A Deep Bed Media Filter

(71) Applicants: Jeffrey Brooks, Wixom, MI (US); Joe Haligowski, Troy, MI (US); Scott Bratten, West Bloomfield, MI (US)

(72) Inventors: Jeffrey Brooks, Wixom, MI (US); Joe Haligowski, Troy, MI (US); Scott Bratten, West Bloomfield, MI (US)

(21) Appl. No.: 16/593,220

(22) Filed: Oct. 4, 2019

Related U.S. Application Data
(60) Provisional application No. 62/741,012, filed on Oct. 4, 2018.

(51) Int. Cl. B01D 17/02; B01D 17/00; B01D 17/12; B01D 24/12; B01D 24/46; C02F 1/00; C02F 1/40

(52) U.S. Cl. CPC B01D 17/0214; B01D 17/10; B01D 17/12; B01D 24/12; C02F 2101/32; C02F 1/004; C02F 1/40; C02F 1/008; B01D 24/4631

(57) ABSTRACT

A deep media bed filter is combined with an oil skimmer integrated into the filter, the oil skimmer including an arrangement for collecting oil floating on the water to be filtered in a filter tank. In an unpressurized version of the filter, the level of water to be filtered in the tank is controlled so as to normally not flow over an annular trough inside wall located at the top of the tank. The inside wall of the trough thereby acting as a weir extending around the inner perimeter of the annular trough to be able to receive oil flowing over the weir. When a predetermined oil accumulation atop the water is detected by an interface detector, the water level in the tank is increased sufficiently so that the oil be high enough to pass over the weir and into the annular trough. The collected oil is thereafter drained out of the annular trough as by gravity into a vessel. In a pressurized version of the filter, the integrated oil skimmer has an open bottomed chamber located at the top of the filter tank which is open to the pressurized water and oil in the tank and thereby receives the oil accumulating atop the water in the tank. The oil accumulating in the chamber is periodically discharged out of the chamber by the pressure in the tank when an automatic vent valve is opened when oil accumulates in the chamber to a predetermined level detected by an interface detector, and closed after the oil is discharged from the chamber.

### CROSS REFERENCE TO RELATED APPLICATIONS

This application claims the benefit of U.S. provisional patent application Ser. No. 62/741,012 filed on Oct. 4, 2018.

### BACKGROUND OF THE INVENTION

This invention concerns deep bed media filters, in which a mass of a granular media such as crushed walnut shells is contained in a tank and acts to remove solids from the water to be filtered, as described in detail in U.S. Pat. Nos. 5,290,458 and 6,287,474 incorporated herein by reference.

The water to be filtered (including the water in water based solutions) is drawn through the granular media by operation of a pump which captures solids suspended in the water to thereby be filtered out. In the filters shown in the above referenced patents, the media is periodically backwashed to remove the collected solids from the media granules in order to maintain the effectiveness of the filter. The above patents are directed to an improvement in which the media is agitated during backwashing to form a slurry comprised of the solids released from the media granules into the water thereby enhancing the effectiveness of the backwash to restore the full ability of the media granules to capture solids in the water.

U.S. Pat. No. 6,287,474 describes two versions of such a deep bed media filter. In one version, the water to be filtered in the tank is not pressurized and in the other version the water is pressurized within a sealed tank.

A condition sometimes encountered is the presence of relatively large amounts of oil in the water to be filtered, which can be a problem for such filters described above as during agitation and backwashing, the oil mixes with the media granules and coats the same which can limit their ability to capture solids. Also, the oil cannot to be removed from the backwash water, if it binds with the captured solids, which precludes reclaiming the oil.

In the past, problems with the excess of oil in the water have been dealt with by skimming out oil from the water prior to it being introduced into the filter by means of separate oil skimming equipment located upstream of the filter.

However, this approach adds substantially to the complexity and cost of the installation.

It is an object of the present invention to provide an arrangement for effectively skimming oil from the water to be filtered integrated with a deep bed granular media filter.

### SUMMARY OF THE INVENTION

The above recited object and other objects which will be understood by those skilled in the art are achieved by installing a unique integrated oil skimming arrangement within the upper level of the tank of a deep bed granular media filter. The integrated skimmer arrangement takes advantage of the marked tendency for oil to naturally rise up in the water in the filter tank due to the lighter weight of the oil compared to the water. The oil is thereby separated from the water during the filtering process. This is because the flow of unfiltered water through the filter is generally not turbulent, and so the filtration process itself does not disrupt the tendency of the oil to rise and form a separate layer disposed above the water while the filter is operating.

The integrated oil skimmer arrangement includes an oil collector situated to collect the oil after it separates and forms a layer disposed on the upper surface of the water to be filtered in the tank.

In an unpressurized version of the filter, the oil collector comprises an annular trough fixed within an upper region of the tank, located well above a normal operating water level which is maintained within the tank during the filter operation. When a significant volume of oil has accumulated in a layer atop the water in the tank, this is detected by a water-oil-air interface detector (which is commercially available), and the water level in the tank is then slowly increased sufficiently to so as to raise the accumulated oil floating in a layer atop the water to a level where the oil will flow over a weir defined by an inside wall of the trough.

The water level is increased by either increasing the water flow through an inlet valve controlled by a PLC (Programmable Logic Controller), or by decreasing the output of a pump which causes the water in the tank to be drawn down through the media bed and out of the tank.

The oil flowing over the weir is thereby received and collected in the annular trough, which drains out through an outlet, as by gravity, and passes into an oil tote or other container.

In a pressurized version of the filter, an open bottomed chamber is located at the very top of the sealed filter tank, so that when the oil in the water rises up it will eventually enter the open bottomed chamber and displace any water down and out of the chamber therein due to its lighter weight. When the depth of the oil in the chamber reaches a predetermined level detected by the interface detector, the chamber is vented by automatically opening a vent valve connected to the chamber, which causes in the pressurized water in the tank to discharge the oil out from the chamber and into an oil tote. The vent valve is closed after substantially all of the oil has been removed from the chamber as detected by the interface detector.

### DESCRIPTION OF THE DRAWINGS

FIG. 1A is a partially sectional view of an unpressurized deep media bed filter equipped with an integral oil skimmer arrangement according to the invention, with a block diagram depiction of an agitator-backwash assembly associated therewith.

FIG. 1B is a partially sectional view of the filter as shown in FIG. 1A but utilizing an alternative way of controlling the water level in the tank.

FIG. 2 is a fragmentary enlarged sectional view of the upper portion of the unpressurized deep bed media filter shown in FIGS. 1A and 1B which shows an elevated water level causing separated oil to flow into an annular trough used to skim the oil on top of the water in the filter tank.

FIG. 3 is a sectional view of a pressurized deep media bed filter which includes an integrated oil skimmer arrangement suited to a pressurized filter, with an agitator-backwash assembly associated therewith also depicted a block diagram.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

As noted above, the combination of an integrated filter and oil skimmer according to the invention is provided for a deep bed media filter which has an unpressurized or pressurized tank.

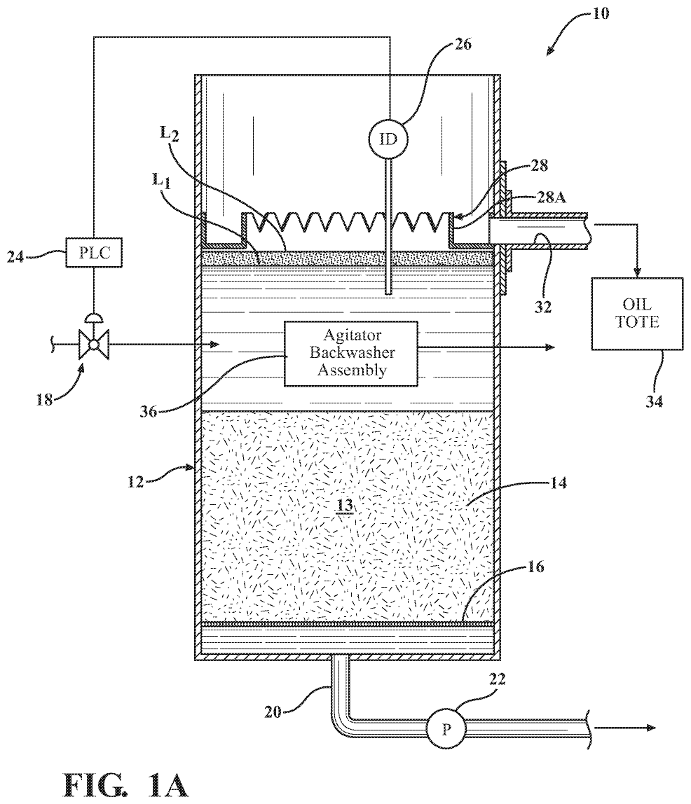

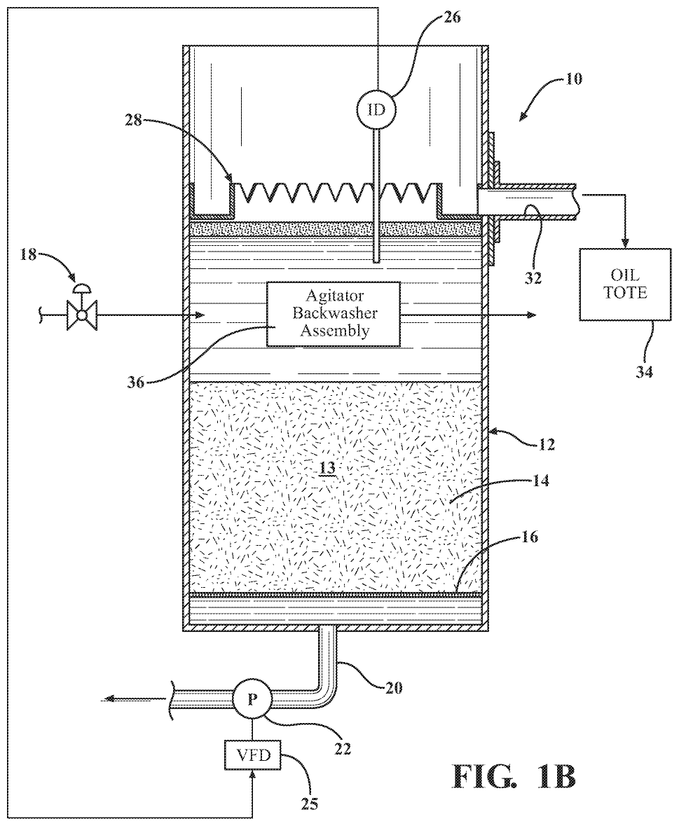

In the unpressurized deep bed media filter 10 shown in FIG. 1A, a granular media bed 13 is disposed in a lower region 14 of the filter tank 12 held above a perforate plate 16 which has openings small enough to prevent the granular media from escaping from the tank. Other arrangements for keeping the granular media in a tank are known, such as disclosed in the cited patent U.S. Pat. No. 5,290,458. Filtered water enters the tank 12 through an inlet valve 18 and is drawn out through an outlet 20 by operation of a pump 22 in the conventional manner.

Unfiltered water enters the tank 12 through the inlet valve 18, at a varying rate controlled by a PLC 24 (Programmable Logic Controller) which receives a signal from an interface detector 26 a commercially available device for a purpose to be described hereinafter.

An annular trough 28 which comprises a skimmed oil collector is fixedly located within the tank 12 at a location near the top of the filter tank 12, at least portions thereof above a normal water level L1 maintained in the tank 12 when the filter is operating without any oil skimming activity.

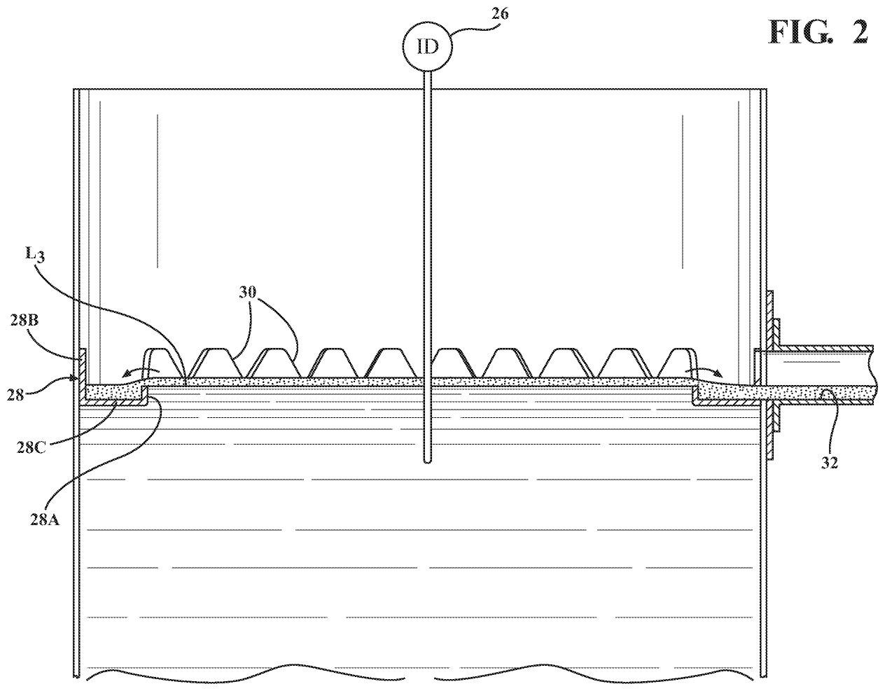

The annular trough 28 is formed by an inner wall 23A, an inside wall 28B and a bottom wall 28C (FIG. 2).

In FIG. 1A, the water level is controlled by varying the water inlet flow rate by operation of an inlet control valve 18. The setting of the inlet control valve 18 is determined by a signal generated by the electronic interface detector 26, a commercially available device, which detects the level where the water meets the oil and generates a corresponding signal. As filtration continues, oil, being lighter than the water, will float to the top of the water in the filter tank 12 so that it can be removed by the integrated skimmer according to the invention. The filter 10 normally runs with a substantially constant flow rate of the water to be filtered and with an increasing pressure drop, as the filter media loads up with solids. The normal operating level L1 is well below the level where oil or water will flow over the inside wall 28A.

The interface detector 26 is also used to constantly the thickness of the oil layer which has formed on top of the water. This is determined by sensing where the top of the oil layer is located by detecting the level L2 where the oil-air interface is by the interface detector 26.

When a significant depth of oil accumulation on top of the water is detected, the control valve 18 is operated by a PLC 24 to allow a greater rate of flow water into the tank 12 which in turn slowly increases the water level in the tank 12 (FIG. 2). This raises the oil layer on the water to a predetermined higher location that will allow the entire oil layer to flow over the inside wall through the notches 30 on the inner sidewall 28A of the annular trough 28. The inner side wall 28A thus acts as a weir to skim the oil from the top of the water.

The notches 30 ensure that the oil flows evenly around the perimeter of the inside wall 28A. The oil collected in the annular trough 28 flows down through a drain 32 connected to the annular trough 28 by gravity into an oil tote 34.

The oil skimming may be ended when the interface detector 26 output signal indicates that water (13) has begun to flow through the notches 30 on the inner sidewall 28A of the annular trough 28. When this happens, the control valve 18 is operated by the PLC 24, so as to lower the rate of inflow and thus the level of water in the tank 12 will be restored to its normal operating level L1, awaiting another skimming cycle when a sufficient depth of oil on the surface of the water is again detected. More than one oil skimming operation may take place over the course of a single filtering cycle.

Referring to FIG. 1B, the water level can alternatively be set by controlling the output of the pump 22 which draws water through the media bed 13, as by use of a VFD 25 (Variable Frequency Drive) connected to the pump 22.

As described in detail in the above referenced U.S. patents, the deep bed media filters are advantageously equipped with an agitation-backwash assembly 36, which is depicted in block diagram form which causes the media to be mixed into the water, which removes solids captured by the media granules and forms a slurry of the solids and the water.

A backwash flow of water and solids is then established, directing the slurry out from the tank 12 to a separate processing location where concentrated solids can be dewatered and disposed of in the well known manner.

The slurry passes through a screen as shown in the patents referenced above, which prevents the media from escaping with the backwash water.

Advantageously, the agitation-backwash operation is programmed to be initiated just after an oil skimming cycle so that only a minimum volume of oil comes into contact with the media granules and also only a minimal volume of oil is lost in the backwash discharge.

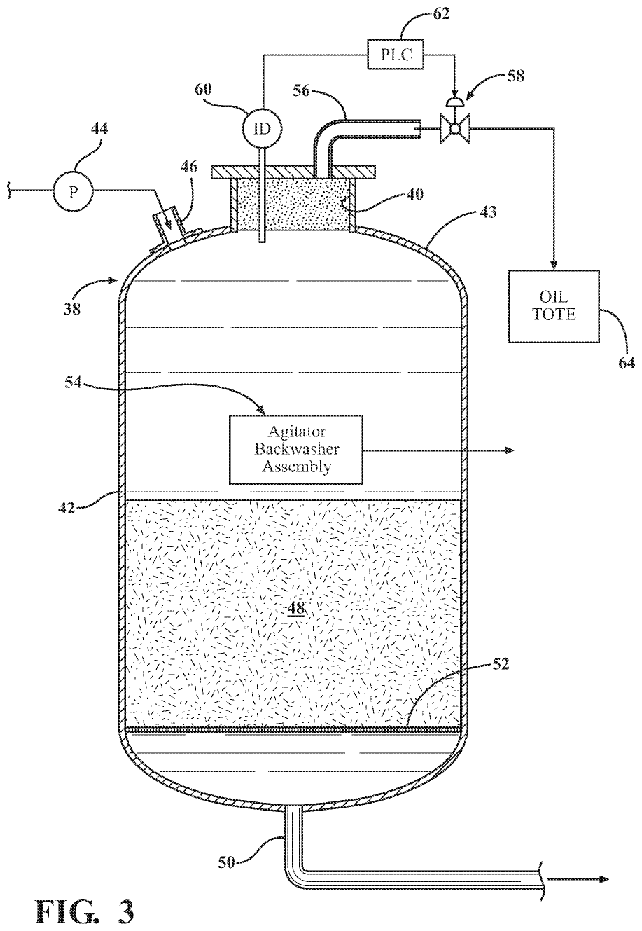

In a pressurized water filter 38 shown in FIG. 3, the integrated oil skimmer includes a chamber 40 comprising the skimmed oil collector located at the top of the filter tank. The chamber 30 is of a much smaller diameter than the tank 42 and has an open bottom which is located at the highest point of the tank 42, open to the interior of the tank 42 so that oil or water in the tank 42 can freely enter the chamber 40. The top 43 of the tank 42 is curved to direct rising oil at the outer region of the tank into the chamber 40.

During filtration, water to be filtered is introduced under pressure developed by a pump 44 into the tank 42 through an inlet 46. As shown in FIG. 3, the water to be filtered is drawn down through the media bed 48 and the clean water discharges out from the bottom of the filter tank 42 via an outlet 50. A perforated plate 52 prevents escape of media out the outlet 50. Other means can also be used to prevent this, as mentioned above.

The pressurized filter 38 also includes an agitator-backwash assembly 54 which is periodically operated to form a slurry which is discharged as a backwash flow to remove solid contaminates from the filter as described in the above referenced patents.

As the filter 38 continues to operate, oil in the wastewater in the tank 42 will rise through the water to the top of the filter tank 42, and guided by said upper curved top wall 43, into the chamber 40 due to its lighter weight, any water in the chamber 40 being forced down and out of the chamber 40 by entry of the oil rising into the chamber 40. A vent line 56 extends from the oil collection chamber 40, with an associated preferably automatically operated valve 58 opening and closing the vent line 56. An interface detector 60, extending down through the oil collection chamber 40, is used to detect where the interface between the oil and the waste water is in order to establish the level of oil in the chamber 40. During normal filtration, the valve 58 will be opened periodically as needed to discharge the volume of oil that has collected in the collection chamber 40. The output of the interface detector 60 controls the opening and closing of the vent valve 58 as by a PLC 62.

Discharged oil is directed into an oil tote 64.

Thus, the present invention comprises the combination of a deep bed media filter with an integrated oil skimmer provided within the filter tank so that the deep media bed filter can handle much higher oil concentrations in the wastewater to be filtered, at a much lower cost than using a separate oil skimmer apparatus upstream of the filter itself.

1. The combination of a deep bed media filter with an integrated oil skimmer comprising:
a tank receiving water to be filtered therein;
a mass of granular media disposed within a lower region of said tank;
an outlet below said media receiving filtered water after passing through said mass of granular media allowing said filtered water but not said granular media to be drawn out of said tank;
an oil skimming collector located in an upper region of said tank arranged to collect any oil accumulating atop said water to be filtered in said tank; and
an oil skimmer outlet directing oil in said oil skimming collector out of said tank.

2. The combination according to claim 1 wherein said filter includes a water level control arrangement which normally maintains a predetermined operating level of water to be filtered in said tank by controlling the flow of water into said tank through said inlet or said flow of water out of said tank through said outlet, said oil skimmer collector comprising an annular trough located having an inner side wall top above said predetermined operating level of water to be filtered maintained in said tank, said inner side wall of said annular trough defining a weir;
said water level in said tank increased from said predetermined operating level by operation of said water level control arrangement when a predetermined thickness of a layer of oil accumulates atop said water in said tank, said water level increased sufficiently to raise said oil layer atop said water so that said oil in said layer thereof is able to pass over said weir and into said trough;
an outlet connected to said trough inner wall so that accumulated oil collected in said annular trough drains out of said annular trough and into a vessel connected thereto.

3. The filter according to claim 2 wherein said weir is notched along the top of said inside wall and wherein said oil layer is raised by increasing said water level sufficiently to allow at least most of said oil to pass through said notches and into said annular trough.

4. The combination according to claim 1 wherein said water to be filtered is directed into said tank which is sealed to pressurize said water in said tank, said oil skimming collector comprising an open bottomed chamber located at the top of said tank and open to said pressurized water in said tank and any oil present in said water so that any oil in said water rises above said pressurized water in said tank during filtration of said water and enters said chamber through said open bottom;
said oil skimmer chamber having a vent valve connected thereto which is opened when an oil level interface detector extending into said chamber detects a predetermined level of oil in said chamber to cause a discharge from said chamber of oil collected therein by the pressure of said water in said tank, said valve thereafter closed after discharging oil collected in said chamber as detected by said interface detector whereby oil is skimmed from said water in said tank.

5. The filter according to claim 4 wherein said filter includes a periodically operated agitator-backwash assembly which forms a slurry of solids removed from the media granules and water, a pump drawing out said slurry from said tank while preventing outflow of said media granules therewith; said agitator-backwash assembly operated just after said oil in said oil skimmer collector is directed out of said tank to thereby minimize the loss of oil with said backwashed slurry.

6. The filter according to claim 5 wherein said tank is of a larger diameter than said chamber and said top of said tank is curved to meet said chamber so as to guide oil rising in said water into said chamber.
